(19) United States
(12) Patent Application Publication
(10) Pub. No.: US 2022/0072696 A1
(43) Pub. Date: Mar. 10, 2022

(54) PALM TOOL DEVICE

(71) Applicant: Hong Ann Tool Industries Co., Ltd., Taichung City (TW)

(72) Inventor: Cheng-Wei SU, Taichung City (TW)

(21) Appl. No.: 17/122,286

(22) Filed: Dec. 15, 2020

(30) Foreign Application Priority Data
Sep. 9, 2020 (TW) 109130896

(51) Int. Cl. B25G 3/18; B25B 13/46; B25B 23/00; B25G 1/06

(52) U.S. Cl. CPC B25G 3/18; B25G 1/063; B25B 23/0028; B25B 13/461

(57) ABSTRACT

A palm tool device includes a drive tool and a bar. The drive tool includes a drive member and a grip member connecting with and housing the drive member. The grip member is annular and surrounds the drive member. An outer periphery of the grip member forms a grip portion and a first attach portion. The bar is selectively attached to and detached from the drive tool. The bar is attachable in at least one position to the drive tool. The bar has a second attach portion and a third attach portion. The bar is attachable in a first position to the drive tool by connecting the second attach portion with the first attach portion. The bar is attachable in a second position to the drive tool by connecting the third attach portion with the engage portion.

### BACKGROUND OF THE INVENTION

### 1. Field of the Invention

The present invention relates to a tool and, particularly, to a palm tool device.

### 2. Description of the Related Art

TW Pat. No. 1696522 discloses a ratchet tool having a first rotating assembly, a second rotating assembly, and a reversing assembly. The first rotating assembly includes a ratchet seat and a first and a second ratchet pivotally disposed on the ratchet seat. Further, the first ratchet member has a first flange adjacent to the ratchet seat and the second ratchet has a second flange adjacent to the ratchet seat, respectively. The second rotating assembly includes a ratchet ring into which the ratchet seat is inserted. The reversing assembly includes a switching member and a pushing member connected to the switching member. The switching member is pivotally disposed on the ratchet seat. The pushing member can selectively push the first and the second flanges.

The ratchet tool is compact and therefore a user can carry and grasp it during the operation easily. However, it is difficult to apply a large torque with the ratchet tool.

The present invention is, therefore, intended to obviate or at least alleviate the problems encountered in the prior art.

### SUMMARY OF THE INVENTION

According to the present invention, a palm tool device includes a drive tool and a bar. The drive tool includes a drive member for engaging with an object to be driven and a grip member connecting with and housing the drive member. The drive member includes an engage portion with which with the object to be driven is adapted to engage. The grip member is annular and surrounds the drive member. An outer periphery of the grip member forms a grip portion for allowing a user to hold the drive tool and a first attach portion. The bar is selectively attached to and detached from the drive tool. The bar is attachable in at least one position to the drive tool. The bar has a second attach portion and a third attach portion. The bar is attachable in a first position to the drive tool by connecting the second attach portion with the first attach portion. The bar is attachable in a second position to the drive tool by connecting the third attach portion with the engage portion.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the assemblys set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a palm tool device in accordance with the present invention, with the palm tool device in a first configuration.

FIG. 2 is an exploded perspective view of the palm tool device.

FIG. 3 is a partial cross-sectional view of the palm tool device.

FIG. 4 is another partial cross-sectional view of the palm tool device.

FIG. 5 is another partial cross-sectional view illustrating parts of the palm tool device in a different relative position from FIG. 4.

FIG. 6 is an exploded perspective view of the palm tool device, with the palm tool device in a second configuration.

### DETAILED DESCRIPTION OF THE INVENTION

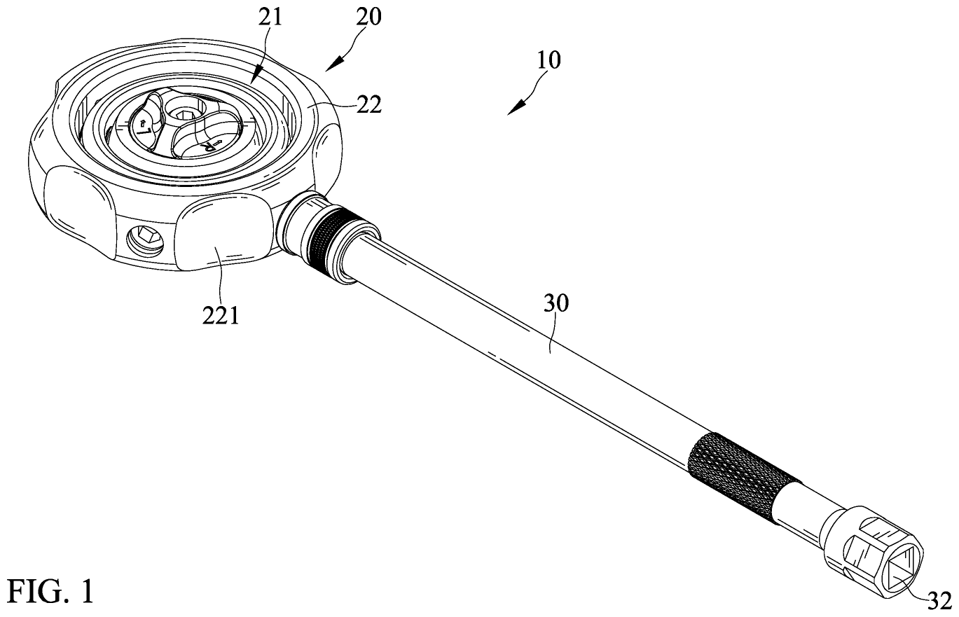

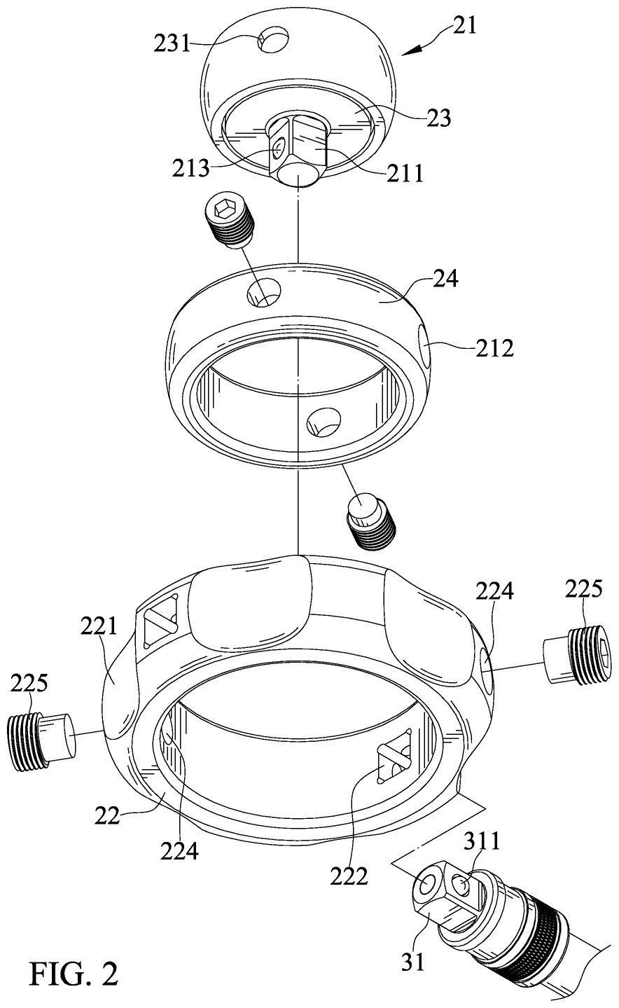

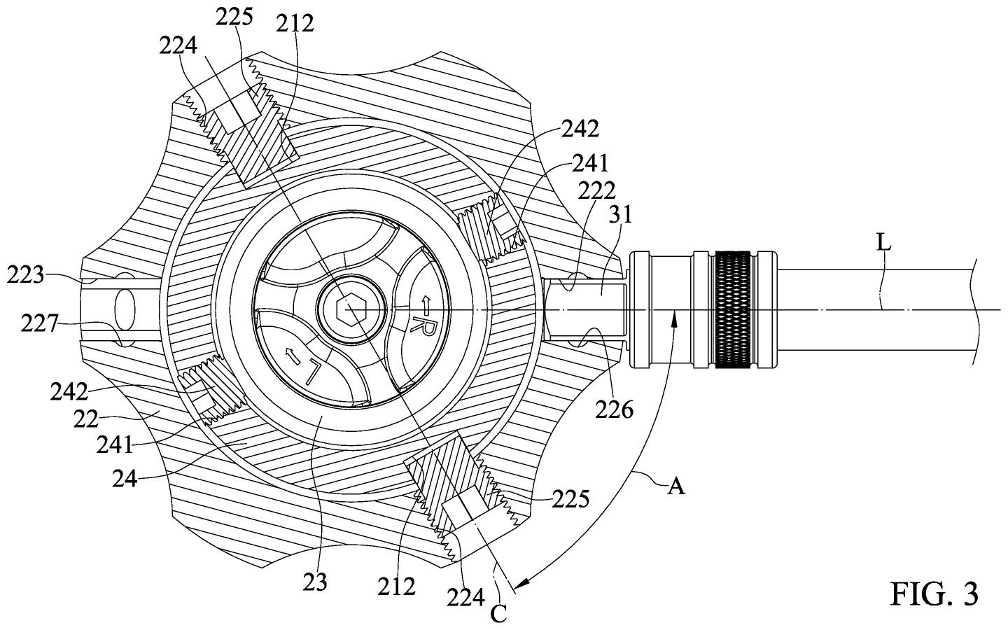

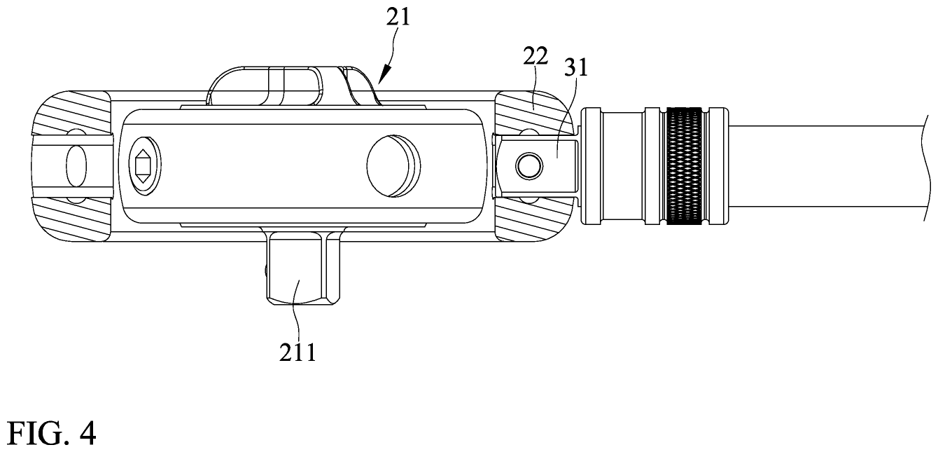

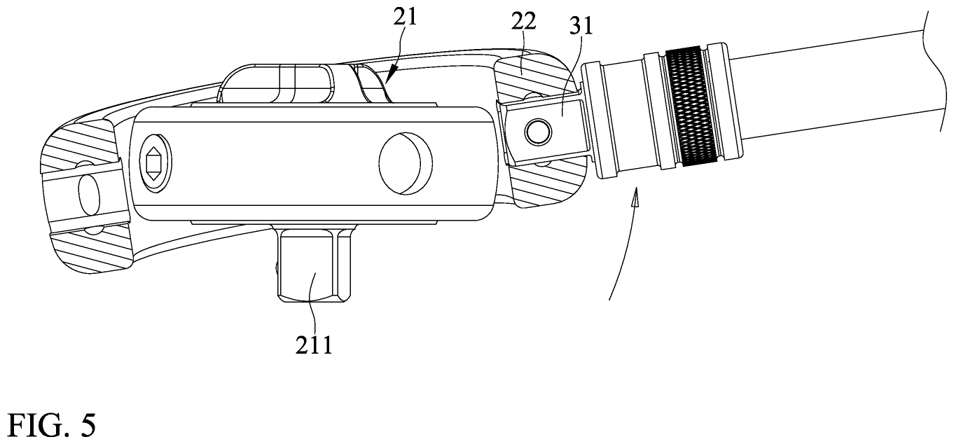

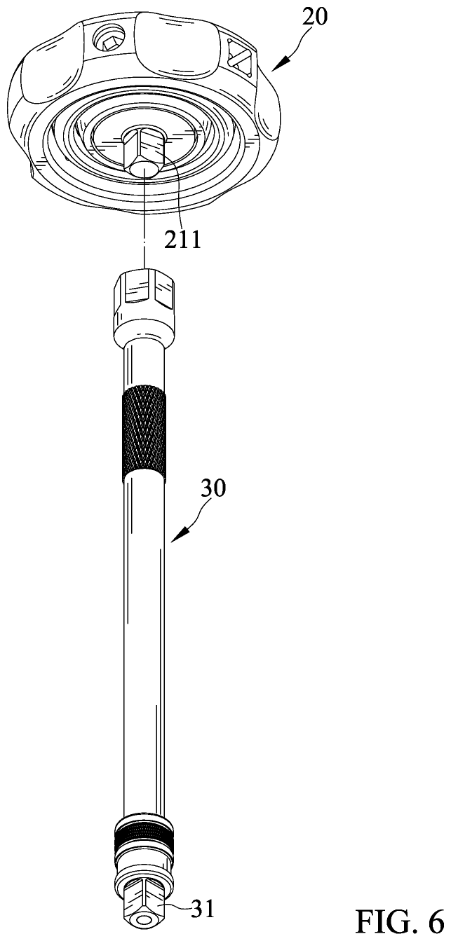

FIGS. 1 through 6 show a palm tool device in accordance with the present invention. The palm tool device 10 includes a drive tool 20 and a bar 30 selectively attached to and detached from the drive tool 20.

The drive tool 20 includes a drive member 21 for engaging with an object to be driven and a grip member 22 connecting with and housing the drive member 21.

The drive member 21 includes an engage portion 211 with which with the object to be driven is adapted to engage. The drive member 21 has at least one hole 212. In the embodiment, the at least one hole 212 has two holes. 212. The two holes 212 are disposed diametrically oppositely. The drive member 21 includes a head 23 and a ring 24 connecting with and housing the head 23. The ring 24 is annular and surrounds the head 23. The at least one hole 212 is defined on the ring 24. The head 23 has at least one hole 231 and the ring 24 has at least one hole 241 corresponding to the at least one hole 231. In the embodiment, the at least one hole 231 has two holes 231 and the at least one hole 241 has two holes 241. The at least one hole 231 and the at least one hole 241 include a fastener 242 inserted therein. The head 23 and the ring 24 are attached with each other. The at least one hole 241 and the fastener 242 are in thread engagement. The at least one hole 241 has inner threads and the fastener 242 has outer threads engaged with the inner threads. The head 23 has a mark “R” and a mark “L”. The mark “R” implies that the head 23 is adapted to drive the object to be driven in a first direction, whereas the mark “L” implies that the head 23 is adapted to drive the object to be driven in a second direction counter to the first direction. The marks “R” and “L” are not limited thereto.

The grip member 22 is annular and surrounds the drive member 21. An outer periphery of the grip member 22 forms a grip portion 221 for allowing a user to hold the drive tool 20 and an attach portion 222 and an attach portion 223. The attach portions 222 and 223 are disposed diametrically oppositely. Each of the attach portions 222, 223 has a quadrilateral cross section. The attach portion 222 has a lock portion 226 in a form of a recess and the attach portion 223 has a lock portion 227 in a form of a recess, respectively. The grip member 22 and the drive member 21 are pivotally connected with each other such that the grip member 22 is pivotal relatively to the drive member 21 about an axis of rotation C. The grip member 22 has at least one through hole 224 corresponding to the at least one hole 212. The at least one through hole 224 extends through the inner periphery and the outer periphery of the grip member 22. In the embodiment, the at least one through hole 224 has two through holes 224. The two through holes 224 are disposed diametrically oppositely. The at least one first hole 212 and the at least one through hole 224 include a pivot 225 inserted therein. The grip member 22 is pivotal relatively to the drive member 21 about the pivot 225.

The bar 30 has an attach portion 31 and an attach portion 32. The bar 30 extends longitudinally along an axis L between the attach portions 31 and 32. The attach portions 31 and 32 are at opposite ends of the bar 30 or the axis L. The attach portions 32 has a quadrilateral cross section.

The bar 30 is attachable in a first position to the drive tool 20 by connecting the attach portion 31 with the attach portion 222. The attach portion 31 includes a detent ball 311 movably mounted thereon and being movable in a radial direction for releasably attaching the bar 30 in the first position to the drive tool 20. The detent ball 311 is selectively locked in and unlocked from the lock portion 226. The detent ball 311 is locked in the lock portion 226 when the bar 30 is attached in the first position to the drive tool 20, i.e., the attach portion 222.

The palm tool device 10 is in a first configuration when the bar 30 is attached in the first position to the drive tool 20, with the attach portion 31 connected with the attach portion 222. The axis L and the axis of rotation C intersect with each other when the bar 30 is attached in the first position to the drive tool 20 and an included angle A therebetween is less than 90 degrees.

The bar 30 is attachable in a second position to the drive tool 20 by connecting the attach portion 32 with the engage portion 211. The engage portion 211 includes a detent ball 213 movably mounted thereon and being movable in a radial direction for releasably attaching the bar 30 in the second position to the drive tool 20.

The palm tool device 10 is in a second configuration when the bar 30 is attached in the second position to the drive tool 20, with the attach portion 32 is connected with the engage portion 211. Additionally, the attach portion 31 is selectively connectible with the attach portions 222 and 223. The detent ball 311 is locked in the lock portion 227 when the bar 30 is attached to the attach portion 223 of the drive tool 20.

In view of the foregoing, when a user encounters a difficulty in operating the drive tool 20 to apply enough torque to drive an object, the bar 30 can be attached to the drive tool and used as leverage.

The foregoing is merely illustrative of the principles of this invention and various modifications can be made by those skilled in the art without departing from the scope and spirit of the invention.

What is claimed is:

1. A palm tool device comprising:
a drive tool including a drive member for engaging with an object to be driven and a grip member connecting with and housing the drive member, wherein the drive member includes an engage portion with which with the object to be driven is adapted to engage, wherein the grip member is annular and surrounds the drive member, and wherein an outer periphery of the grip member forms a grip portion for allowing a user to hold the drive tool and a first attach portion; and
a bar selectively attached to and detached from the drive tool, wherein the bar is attachable in at least one position to the drive tool, wherein the bar has a second attach portion and a third attach portion, wherein the bar is attachable in a first position to the drive tool by connecting the second attach portion with the first attach portion, and wherein the bar is attachable in a second position to the drive tool by connecting the third attach portion with the engage portion.

2. The palm tool device as claimed in claim 1, wherein the outer periphery of the grip member forms a fourth attach portion, wherein the second attach portion is selectively connectible with the first and the fourth attach portions, and wherein the first and the fourth attach portions are disposed diametrically oppositely.

3. The palm tool device as claimed in claim 1, wherein the drive member and the grip member are pivotally connected with each other such that the grip member is pivotal relatively to the drive member about an axis of rotation, wherein the bar extends longitudinally along an axis between the second and the third attach portions, and wherein the axis and the axis of rotation intersect with each other when the bar is attached in the first position to the drive tool and an included angle therebetween is less than 90 degrees.

4. The palm tool device as claimed in claim 2, wherein the drive member and the grip member are pivotally connected with each other such that the grip member is pivotal relatively to the drive member about an axis of rotation, wherein the bar extends longitudinally along an axis between the second and the third attach portions, and wherein the axis and the axis of rotation intersect with each other when the bar is attached in the first position to the drive tool and an included angle therebetween is less than 90 degrees.

5. The palm tool device as claimed in claim 3, wherein the drive member has at least one first hole and the grip member has at least one through hole corresponding to the at least one first hole, wherein the at least one first hole and the at least one through hole include a pivot inserted therein, and wherein the grip member is pivotal relatively to the drive member about the pivot.

6. The palm tool device as claimed in claim 4, wherein the drive member has at least one first hole and the grip member has at least one through hole corresponding to the at least one first hole, wherein the at least one first hole and the at least one through hole include a pivot inserted therein, and wherein the grip member is pivotal relatively to the drive member about the pivot.

7. The palm tool device as claimed in claim 5, wherein the at least one first hole of the drive member has two first holes and the at least one through hole of the grip member has two through holes, wherein the two first holes are disposed diametrically oppositely, and wherein the two through holes are disposed diametrically oppositely.

8. The palm tool device as claimed in claim 6, wherein the at least one first hole of the drive member has two first holes and the at least one through hole of the grip member has two through holes, wherein the two first holes are disposed diametrically oppositely, and wherein the two through holes are disposed diametrically oppositely.

9. The palm tool device as claimed in claim 5, wherein the drive member includes a head and a ring connecting with and housing the head, wherein the ring is annular and surrounds the head, and wherein the at least one first hole is defined on the ring.

10. The palm tool device as claimed in claim 6, wherein the drive member includes a head and a ring connecting with and housing the head, wherein the ring is annular and surrounds the head, and wherein the at least one first hole is defined on the ring.

11. The palm tool device as claimed in claim 9, wherein the head has at least one second hole and the ring has at least one third hole corresponding to the at least one second hole, wherein the at least one second hole and the at least one third hole include a fastener inserted therein, and wherein the head and the ring are attached with each other.

12. The palm tool device as claimed in claim 10, wherein the head has at least one second hole and the ring has at least one third hole corresponding to the at least one second hole, wherein the at least one second hole and the at least one third hole include a fastener inserted therein, and wherein the head and the ring are attached with each other.

13. The palm tool device as claimed in claim 1, the second attach portion includes a first detent ball movably mounted thereon and being movable in a radial direction for releasably attaching the bar in the first position to the drive tool.

14. The palm tool device as claimed in claim 13, wherein the engage portion includes a second detent ball movably mounted thereon and being movable in a radial direction for releasably attaching the bar in the second position to the drive tool.

15. The palm tool device as claimed in claim 2, the second attach portion includes a first detent ball movably mounted thereon and being movable in a radial direction for releasably attaching the bar in the first position to the drive tool.

16. The palm tool device as claimed in claim 15, wherein the engage portion includes a second detent ball movably mounted thereon and being movable in a radial direction for releasably attaching the bar in the second position to the drive tool.

17. The palm tool device as claimed in claim 2, wherein each of the third attach portion and the first and the fourth attach portions has a cross section with plurality of sides.

18. The palm tool device as claimed in claim 13, wherein the first attach portion has a first lock portion in a form of a recess and the first detent ball is selectively locked in and unlocked from the first lock portion, and wherein the first detent ball is locked in the first lock portion when the bar is attached in the first position to the drive tool.

19. The palm tool device as claimed in claim 15, wherein the first attach portion has a first lock portion in a form of a recess and the first detent ball is selectively locked in and unlocked from the first lock portion, wherein the fourth attach portion has a second lock portion in a form of a recess and the first detent ball is selectively locked in unlocked from the second lock portion, wherein the first detent ball is locked in the first lock portion when the bar is attached to the first attach portion of the drive tool, and wherein the first detent ball is locked in the second lock portion when the bar is attached to the fourth attach portion of the drive tool.
